(19) United States
(12) Patent Application Publication
(10) Pub. No.: US 2014/0094183 A1
(43) Pub. Date: Apr. 3, 2014

(54) RESOURCE ALLOCATION FOR D2D COMMUNICATION

(71) Applicant: Broadcom Corporation, Irvine, CA (US)

(72) Inventors: Chunyan Gao, Beijing (CN); Haiming Wang, Beijing (CN); Sami-Jukka Hakola, Kempele (FI); Timo Kalevi Koskela, Oulu (FI)

(73) Assignee: Broadcom Corportion, Irvine, CA (US)

(21) Appl. No.: 14/119,328

(22) PCT Filed: May 25, 2011
(86) PCT No.: PCT/CN2011/074669

§ 371 Date: Nov. 21, 2013

(51) Int. Cl. H04W 72/04

(52) U.S. Cl. CPC H04W 72/04
USPC 455/450

(57) ABSTRACT

There is provided a mechanism for allocating communication resources of a cellular communication network to a D2D communication. After an eNB has configured a number of resource pools indicating a set of resources usable in the D2D communication, D2D clusters which share a same resource pool are enabled to obtain resources for their respective D2D communication. By detecting the current resource utilization state in the allocated resource pool by measurement on the UE side, it is decided whether suitable resources are available or not. An overload situation is signalled to the eNB if no suitable resource can be detected.

### BACKGROUND OF THE INVENTION

### Field of the Invention

The present invention relates to a mechanism usable for allocating communication resources like frequency channels, time slots and the like of a communication network to a device-to-device communication connection between two or more communication network elements or devices, such as user equipments or the like. In particular, the present invention is related to apparatuses, methods and computer program products providing a mechanism by means of which a resource allocation for a device-to-device communication is achievable with high resource efficiency and low signaling overhead.

The following meanings for the abbreviations used in this specification apply:

BS: base station
CDM: channel division multiplex
CH: cluster head
CQI: channel quality indication
D2D: device-to-device
DL: downlink
eNB: enhanced node B
FDM: frequency division multiplex
ID: identification

### LTE: Long Term Evolution

### LTE-A: LTE Advanced

OI: overload indication
PRB: physical resource block
PUCCH: physical uplink control channel
PUSCH: physical uplink shared channel
RNTI: radio network temporary identifier
RRC: radio resource control
RU: resource utilization
SN: slave node
TDD: time division duplex
TDM: time division multiplex
Tx: transmission
UE: user equipment
UL: uplink

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) communication networks like the Universal Mobile Telecommunications System (UMTS), enhanced communication networks based e.g. on LTE, cellular 2nd generation (2G) communication networks like the Global System for Mobile communications (GSM), the General Packet Radio System (GARS), the Enhanced Data Rates for Global Evolutions (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

For future cellular communication networks, high communication speed, large capacity and a high quality of service are important features to be achieved. As one feature used in future communication networks for achieving these goals, the implementation of D2D communications is considered as a feature to be supported by next generation cellular networks. Advantages achievable by the implementation of D2D communications in the cellular communication environment are, for example, an offloading of the cellular system, reduced battery consumption due to lower Tx power, an increased data rate, improve local area coverage robustness to infrastructure failures and also enabling of new services. This is possible while also providing access to licensed spectrum with a controlled interference environment to avoid the uncertainties of license exempt band. Due to this, D2D communication gains more and more attraction and interest both in industry and academy of telecommunications.

For the integration of D2D communication solutions into cellular communication systems like 3GPP LTE or LTE-A based networks, there are different approaches conceivable which can mainly be classified into two categories. One category is referred to as autonomous D2D, and the other category is referred to as base station or eNB controlled in-band D2D.

In case of using an eNB controlled in-band D2D based approach, there are several alternatives possible for actually realizing it, depending on how firm the control from eNB side is to be set. For example, in the most extreme case, the eNB may allocate resources for each D2D pair or cluster (a D2D cluster is usually referred to a scenario where more than two devices or UEs participate on a D2D communication; for the sake of simplicity, in the following, a D2D cluster or group may also used to define a case where only two devices or UEs (i.e. a D2D pair) comprised), and schedules the transmission in each D2D cluster. By means of this, the implementation requirement may be released at the device side, however at the cost of an increased eNB burden. Furthermore, as a disadvantage in this scenario, a signaling overhead may be heavy in case of large number of D2D pairs/clusters, since a separate control for each D2D pair/cluster is required. In this connection, it is to be noted that also signaling over cellular links consumes actually time resources from the D2D communication when assuming simultaneous cellular and D2D communication is not possible in usual cases. Furthermore, in such a scenario, newly employed measurement and report mechanisms need to be introduced in order to help for a resource allocation at eNB side so as to enable resource reuse in view of resource efficiency. Another issue in such a scenario is that to save signaling overhead, the control from eNB for each D2D pair/cluster may be semi-static, wherein however it may be complicated to adapt to the link quality and traffic status. As a result, the performance and resource efficiency may be reduced.

On the other hand, when using an autonomous D2D approach, the device (UE) is allowed to obtain the resources for D2D communication in an autonomous way via sensing. According to one proposal, the eNB may broadcast the resource allocation in the cellular network. By detecting the broadcast information, the device or UE is able to recognize which PRBs are utilized by cellular UEs. Then, the device may measure the allocated resource to check the interference level. The measurement results may be explored to help to decide whether this is a usable resource for a D2D communication.

Even though the above described approach is able to achieve high resource efficiency, it is difficult to implement this approach in an actual network. The reason is that the resource allocation at the eNB side may be dynamically changing. Thus, when only based on measurement, the D2D device is not able to avoid interference from/to other cellular UEs.

Since the eNB controlled in-band D2D approach promises a higher quality of service, high resource efficiency and a better controllability by operators, it is assumed to have a better applicability compared to the autonomous D2D approach in current considerations for future communication systems.

As one main problem in a deployment scenario of D2D in a cellular communication network, such as an LTE based network, it is to be considered how to allocate resource to a D2D pair/cluster. For example, by using an approach where a dedicated resource for each D2D pair/cluster is assigned, even though the interference to/from D2D could be reduced, the resource efficiency will be significantly reduced.

Furthermore, if the eNB controls the resource allocation for each D2D pair/cluster, the signaling overhead will be heavy, in particular in case of a large number of D2D clusters. Furthermore in order to enable the eNB to decide which D2D clusters can share same resources, it is necessary that the eNb has knowledge about interference between different D2D clusters. For this it is required to introduce new measurement and possibly large feedback for interference reports which decreases the system performance.

On the other hand, in case all D2D pairs/clusters can decide autonomously about the usage of resources, it is not possible to guarantee a suitable interference level since the resource allocation of cellular users is changing dynamically (for example due to a fast scheduling with an interval of 1 ms, or the like).

### SUMMARY OF THE INVENTION

Therefore, a more advanced resource allocation method is desired which allows the communication network, e.g. the eNB, to balance the control signaling and the resource allocation efficiency.

It is an object of the invention to provide an apparatus, method and computer program product by means of which an improved mechanism usable for allocating communication resources to a D2D communication between two or more communication network elements is provided. Specifically, it is

This object is achieved by the measures defined in the attached claims.

According to an example of an embodiment of the proposed solution, there is provided, for example, an apparatus comprising a transceiver configured to conduct a communication with communication network elements, a resource pool configuration processing portion configured to configure one or more resource pools each comprising a plurality of dedicated communication resources usable for a device-to-device communication between two or more communication network elements, an allocation processing portion configured to allocate at least one of the one or more resource pools to a group of communication network elements establishing a device-to-device communication connection, wherein the at least one of the one or more resource pools is allocated to the group of communication network elements for allowing a group head communication network element to select a set of communication resources comprised in the least one of the one or more resource pools for the device-to-device communication connection to be established, and wherein the allocation processing portion is configured to send information indicating the at least one of the one or more resource pools to the group head communication network element.

Furthermore, according to an example of an embodiment of the proposed solution, there is provided, for example, a method comprising conducting a communication with communication network elements, configuring one or more resource pools each comprising a plurality of dedicated communication resources usable for a device-to-device communication between two or more communication network elements, allocating at least one of the one or more resource pools to a group of communication network elements establishing a device-to-device communication connection, and sending information indicating the at least one of the one or more resource pools to a group head communication network element, wherein the at least one of the one or more resource pools is allocated to the group of communication network elements for allowing the group head communication network element to select a set of communication resources comprised in the least one of the one or more resource pools for the device-to-device communication connection to be established.

In addition, according to an example of an embodiment of the proposed solution, there is provided, for example, an apparatus comprising a transceiver configured to conduct a device-to-device communication with at least one communication network element and to communicate with a communication network control element, a resource information obtaining processing portion configured to obtain from the communication network control element information indicating at least one allocated resource pool, wherein each resource pool comprises a plurality of dedicated communication resources usable for a device-to-device communication between two or more communication network elements, and a resource state determination processing portion configured to determine, based on a detection of a foreign resource utilization signaling from another communication network element, which communication resources of the plurality of dedicated communication resources of the allocated at least one resource pool are improper for being used as a resource for a device-to-device communication or which communication resources of the plurality of dedicated communication resources of the allocated at least one resource pool are suitable for being used as a resource for a device-to-device communication.

Furthermore, according to an example of an embodiment of the proposed solution, there is provided, for example, a method comprising establishing a device-to-device communication with at least one communication network element and communicating with a communication network control element, obtaining from the communication network control element information indicating at least one allocated resource pool, wherein each resource pool comprises a plurality of dedicated communication resources usable for a device-to-device communication between two or more communication network elements, and determining, based on a detection of a foreign resource utilization signaling from another communication network element, a resource state indicating which communication resources of the plurality of dedicated communication resources of the allocated at least one resource pool are improper for being used as a resource for a device-to-device communication or which communication resources of the plurality of dedicated communication resources of the allocated at least one resource pool are suitable for being used as a resource for a device-to-device communication.

In addition, according to an example of an embodiment of the proposed solution, there is provided, for example, an apparatus comprising a transceiver configured to conduct a device-to-device communication with at least one communication network element, wherein one of the at least one communication network element is a master node of the device-to-device communication, and a resource obtaining processing portion configured to obtain, on the basis of a detection of a resource utilization signaling from the master node of the device-to-device communication, communication resources of a plurality of dedicated communication resources as resources for the device-to-device communication.

Furthermore, according to an example of an embodiment of the proposed solution, there is provided, for example, a method comprising establishing a device-to-device communication with at least one communication network element, wherein one of the at least one communication network element is a master node of the device-to-device communication, and obtaining, on the basis of a detection of a resource utilization signaling from the master node of the device-to-device communication, communication resources of a plurality of dedicated communication resources as resources for the device-to-device communication.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

Basically, according to examples of embodiments of the invention, a semi-distributed resource allocation solution for D2D is proposed which satisfies the requirement to allow the communication network to balance the control signaling and the resource allocation efficiency. For example, according to examples of embodiments of the invention, since a D2D communication is usually limited to a smaller local area (compared to the area of e.g. a cell of a cellular communication network), resources allocated to one D2D cluster can be allocated to another D2D cluster or to a cellular user without critical interference since the company D2D cluster or cellular UE can be selected properly.

By virtue of the proposed solutions, it is possible to provide an advanced resource allocation solution where the interference can be controlled by a communication network control element, such as a BS or eNB, while a high resource efficiency is achievable. Furthermore, the proposed solution can be applied to UEs with different communication capability. Moreover, a low signaling overhead is required, and the solution is also easily implementable in existing communication networks.

Specifically, the proposed resource allocation solution and the signaling used for implementing the resource allocation allow the BS or eNB to control a number of D2D pairs/clusters sharing resources in a same resource pool so as to find a balance between the probability of collision and resource efficiency. Furthermore, it enables clusters sharing the same resource pool to obtain the resource for their D2D communication in a “cognitive” way with a certain level of autonomy so that control signaling from/to the BS/eNB can be spared. Moreover, according to examples of embodiments of the invention, it is possible that a cluster indicates an overload status to the BS/eNB and to request a new D2D resource pool, so that collisions can be avoided while it is avoided to wait for a long time in a pure contention-based scheme. Additionally, the proposed resource allocation solution and signaling allows the BW/eNB to achieve information on a D2D resource utilization, even on demand, so as to optimize already in advance a resource pool setting. Since the singaling used in the proposed resource allocation solution can be realized also by current transmission formats of e.g. an LTE based network, new signaling formats or the like are not required to be introduced, so that complexity in both specification and implementation can be reduced significantly when implementing the proposed resource allocation solution.

The above and still further objects, features and advantages of the invention will become more apparent upon referring to the description and the accompanying drawings.

### BRIEF DESCRIPTION OF THE DRAWINGS

FIG. 1 shows a diagram illustrating a communication network structure where examples of embodiments of the invention are applicable.

FIG. 2 shows a flowchart illustrating a processing executed in a communication network control element like a base station or eNB in a resource allocation procedure according to an example of embodiments of the invention.

FIG. 3 shows a flowchart illustrating a processing executed in a communication network element like a UE or CH in a resource allocation procedure according to an example of embodiments of the invention.

FIG. 4 shows a signaling diagram illustrating a processing in a resource allocation procedure according to an example of embodiments of the invention.

FIG. 5 shows diagrams illustrating a resource reservation for signaling according to examples of embodiments of the invention.

FIG. 6 shows a block circuit diagram of a communication network control element including processing portions conducting functions according to examples of embodiments of the invention.

FIG. 7 shows a block circuit diagram of a communication network element including processing portions conducting functions according to examples of embodiments of the invention.

### DESCRIPTION OF PREFERRED EMBODIMENTS

In the following, examples and embodiments of the present invention are described with reference to the drawings. For illustrating the present invention, the examples and embodiments will be described in connection with a cellular communication network based on a 3GPP LTE system.

However, it is to be noted that the present invention is not limited to an application using such types of communication system, but is also applicable in other types of communication systems and the like.

A basic system architecture of a communication network may comprise a commonly known architecture of a communication system comprising a wired or wireless access network subsystem and a core network. Such an architecture may comprise one or more access network control elements, radio access network elements, access service network gateways or base transceiver stations, such as a base station (BS) or eNB, with which a communication network element or device such as a UE or another device having a similar function, such as a modem chipset, a chip, a module etc., which can also be part of a UE or attached as a separate element to a UE, or the like, is capable to communicate via one or more channels for transmitting several types of data. Furthermore, core network elements such as gateway network elements, policy and charging control network elements, mobility management entities and the like are usually comprised. With regard to the D2D communication system, a typical master-slave scheme may be employed, wherein according to examples of embodiments of the invention for each group of communication network elements forming a pair or cluster for a D2D communication, one UE is master node or cluster head (also referred to as group head), for example.

The general functions and interconnections of the described elements, depending on the actual network type, are known to those skilled in the art and described in corresponding specifications so that a detailed description thereof is omitted herein. However, it is to be noted that several additional network elements and signaling links may be employed for a communication connection to or from UEs or eNBs, besides those described in detail herein below.

Furthermore, the described network elements, such as communication network elements like UEs or communication network control elements like BSs or eNBs, or the cluster heads and slave nodes of the D2D communication, and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

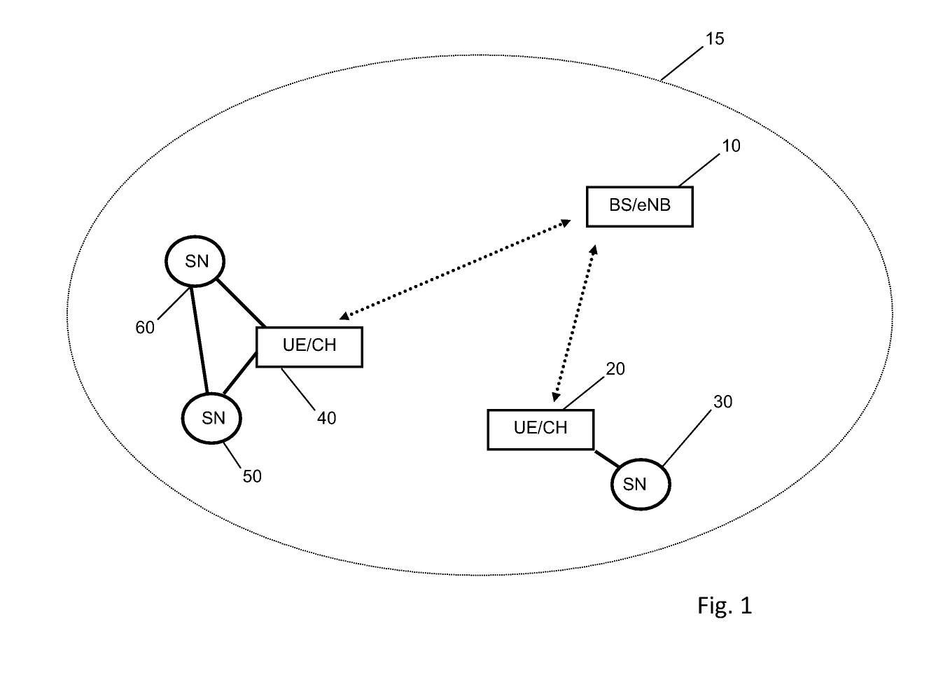

In FIG. 1, a communication network structure is shown which illustrates a scenario where examples of embodiments of the invention are applied. Specifically, in FIG. 1, reference sign 10 denotes a communication network control element, such as an eNB of an LTE based cellular communication network, which is a control element for a specific area 15, also referred to as a cell. In the coverage area 15 of the base station 10, one or more UEs may be located, such as UE 20 and UE 40.

The UEs 20 and 40 may in turn be master nodes or cluster heads of a D2D communication with other devices, such as SN 20 or SNs 50 and 60. It is to be noted that the SNs 20, 50 and 60 may be also UEs of the cellular network, or other communication network elements capable of communicating in the licensed frequency band of the cellular network. For example, the SN 30 may establish a D2D communication connection with UE 20 (i.e. a D2D pair), while SNs 50 and 60 form with UE 40 another D2D communication connection (i.e. a D2D cluster).

It is to be noted that the scenario according to FIG. 1 shows a rather simple case in order to facilitate explanation of the present invention. Furthermore, for the sake of simplicity, a signaling (control signaling and the like) between the UEs 20 and 40 and the BS/eNB 10 is indicated by dashed arrows, wherein signaling between the eNB 10 and one or more of the SNs 30, 50 and 60 may also take place, in particular when the SNs 30, 50 and 60 are also UEs, for example. However, for explaining the examples of embodiments of the invention, signaling between the UEs 20 and 40, which are also cluster heads of the respective D2D communication, and the eNB 10 is considered in the following.

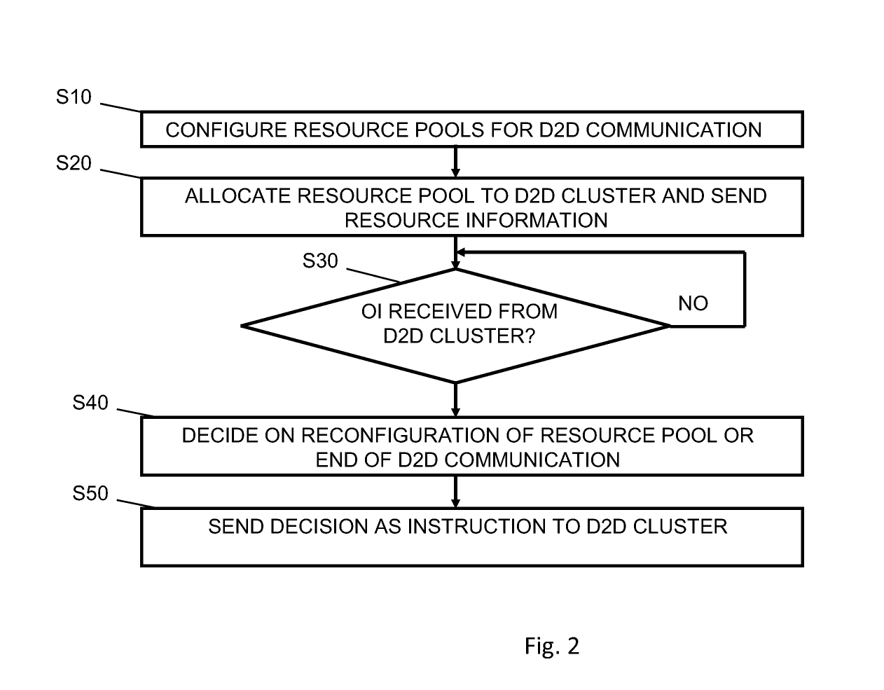

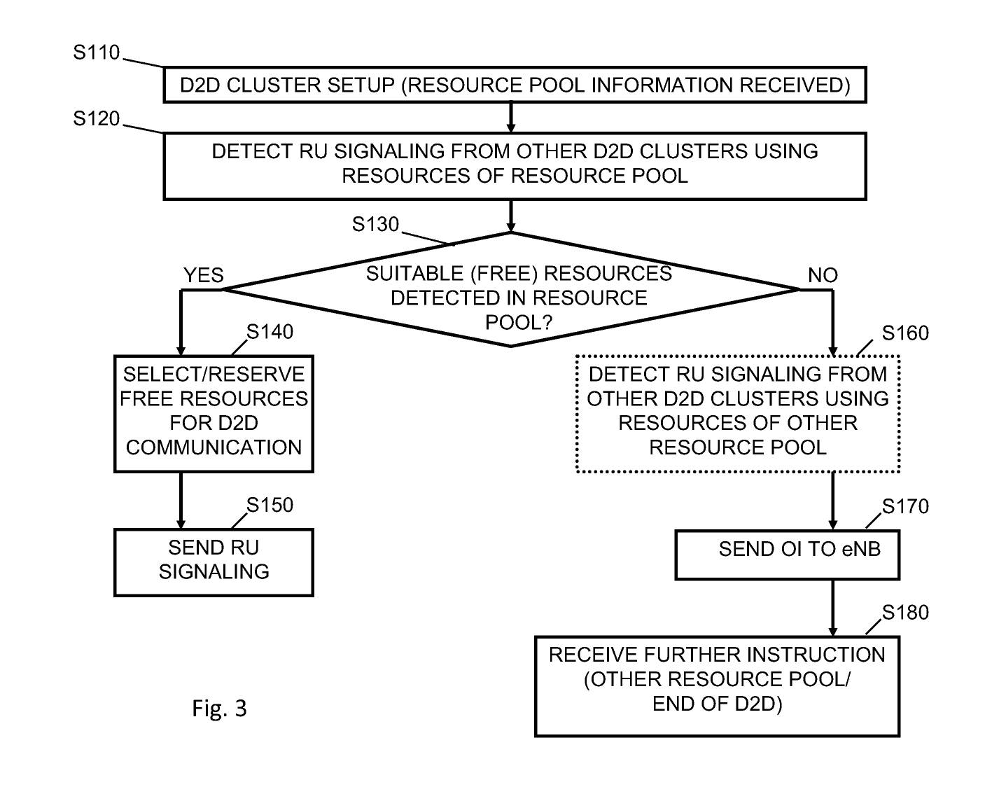

An example of embodiments of the invention is described below with regard to FIGS. 2 and 3. Specifically, FIG. 2 shows a flowchart illustrating a processing executed in a communication network control element like a base station or eNB in a resource allocation procedure according to the present example of embodiments of the invention, while FIG. 3 shows a flowchart illustrating a processing executed in a communication network element like a UE (a CH) in the resource allocation procedure according to the present example of embodiments of the invention.

Basically, according to examples of embodiments of the invention, a procedure for a resource allocation mechanism comprises the following steps.

Firstly, a number of so-called D2D resource pools are configured by the communication network control element eNB. A resource pool indicates a plurality of resources available in the communication network, such as frequency channels or frequency bands, time slots, etc. which can be used in a D2D communication, i.e. which can be occupied by UEs establishing a D2D communication with each other and of which a D2D communication can select. Thus, by configuring the resource pools correspondingly, the eNB is able to control a number of groups of UEs each forming a D2D pair/clusters which share resources in a same resource pool, so as to balance the probability of collision and to increase the resource efficiency.

Secondly, D2D clusters which share a same resource pool are enabled to obtain the resources for their respective D2D communication connection by a cognitive way. That is, the UEs representing a cluster head (CH) can detect the current resource utilization state in the resource pool by own measurement of signaling from other UEs, and decide on their own which of the offered resources are available or free. Due to this, the signaling overhead in a control signaling from/to the eNB can be minimized.

Thirdly, the resource allocation mechanism enables that UEs of a D2D cluster determine and indicate an overload status to the eNB. In this connection, a new or reconfigured D2D resource pool can be requested so as to avoid collisions. Furthermore, in a contention-based scheme, a long waiting time can be avoided.

It is to be noted that, as a further feature in the proposed mechanism, the complete singaling can be realized by current signaling formats, that is to say, no new signaling format is introduced for this purpose, which reduces complexity in both specification and implementation.

Thus, according the the basic concept of examples of embodiments of the invention, it is possible to conduct an interference control at the eNB side, and to enable an efficient resource utilization.

As indicated in FIG. 2, in the resource allocation procedure according to examples of embodiments of the invention, in step S10, the eNB 10 configures one or more D2D resource pools each comprising plural resources of the communication network which are decided to be offered for a D2D communication established in the coverage area of the eNB 10. The number and contents of the resource pools may depend on available resources, load conditions and the like, and may also vary, e.g. depending on a day time or on a current traffic situation, or the like.

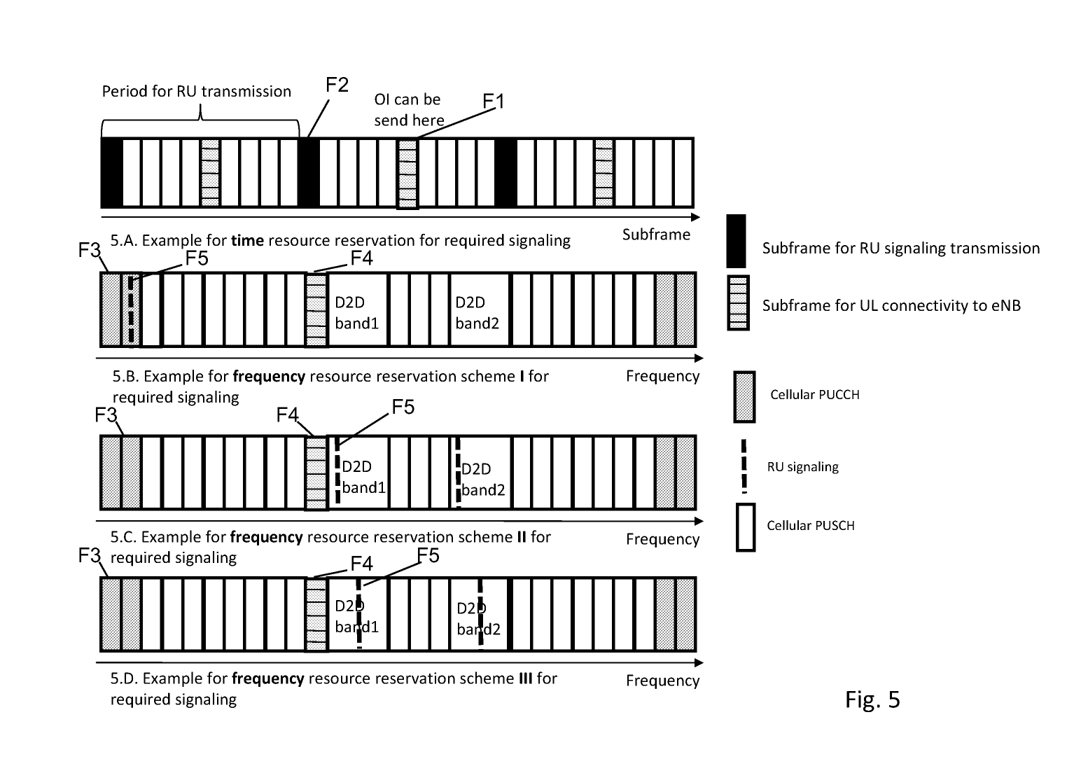

Next, in step S20, the eNB 10 allocates one or more of the configured resource pools to a D2D pair/cluster. For example, the allocation may take place when an indication of one of the UEs participating in the D2D communication is received at the eNB 10. By means of the allocation, the D2D pair/cluster (e.g. D2D cluster comprising elements 20 and 30 in FIG. 1) is configured by the eNB 10 to use the resources included in the allocated one or more D2D resource pools when the D2D communication connection is set up. For this purpose, the eNB 10 sends in step S20 information regarding the allocated resource pool(s) and regarding a signaling setting to the D2D cluster (i.e. at least to the group head or CH of the D2D cluster, such as UE 20), which information comprise at least a communication network element identification in the group (cluster) of communication network elements (i.e. device-IDs of devices in the cluster), a first communication band indication for the D2D communication for the group of communication network elements (i.e. an indication of a frequency band or the like usable for the D2D communication, see also FIG. 5), a (optional) second communication band indication for the D2D communication for the group of communication network elements (i.e. an optional indication of a further frequency band or the like usable for the D2D communication, see also FIG. 5), a resource indication for a connectivity between the D2D cluster and the communication network control element (i.e. an indication of an uplink channel or the like via which information can be sent to the eNB 10, if required), and a resource indication and time period indication for a resource utilization signaling (i.e. an indication of resources in the communication network which is to be used for an RU signaling (to be described later)).

After step S20, the basic set up work for the D2D communication at the eNB side is completed.

In step S30, it is determined whether an overload indication is received from a D2D cluster to which at least one resource pool is allocated by the eNB 10. As long as no such overload indication is received (NO in step S30), the eNB is waiting (wherein an allocation or (re-)configuration of cluster pools for other D2D cluster can be executed in accordance with steps S10 and S20).

When the determination in step S30 is YES, i.e. an OI has been received, the processing proceeds to step S40. In step S40, based on an evaluation of the received OI, i.e. which resource pool is concerned, and the overall situation in the cell, i.e. the availability of other resources or resource pools, the eNB 10 decides about the further state of the D2D connection concerned (i.e. the D2D cluster from which the OI is received). For example, the eNB 10 decides that there are other available and free resources, so that it either reconfigures the present resource pool allocated to the OI sending D2D cluster (by adding or replacing resources, for example), or determines another one of the configured resource pools, wherein the new resource pool is again allocated to the D2D cluster and signalled to the CH (e.g. UE 20) in step S50. On the other hand, in case no further resources are available, or the like, the termination of the D2D communication establishement is decided, wherein a corresponding instruction is sent in step S50 towards the OI sending D2D cluster (i.e. UE 20 as CH).

It is to be noted that the eNB 10 may configure multiple D2D pair/clusters to share the same D2D resource pool. For example, the same resource pool may be indicated to both UE 20 and UE 40 in FIG. 1.

Next, with regard to FIG. 3, the processing conducted in the UE 10 (representing a CH) in the resource allocation mechanism according to the present example of embodiments of the invention is described.

When establishing a D2D communication, each D2D pair/cluster occupies a part of the configured D2D resource pool allocated by the eNB 10 in step S20 of FIG. 2. For this purpose, in step S110, the CH of the D2D cluster to be set up receives the information indicating the resource pool send in step S20 of FIG. 2. As mentioned above, the information regarding the allocated resource pool(s) and regarding a signaling setting comprise at least a communication network element identification in the group (cluster) of communication network elements (i.e. device-IDs of devices in the cluster), a first communication band indication for the D2D communication for the group of communication network elements (i.e. an indication of a frequency band or the like usable for the D2D communication, see also FIG. 5), a (optional) second communication band indication for the D2D communication for the group of communication network elements (i.e. an optional indication of a further frequency band or the like usable for the D2D communication, see also FIG. 5), a resource indication for a connectivity between the D2D cluster and the communication network control element (i.e. an indication of an uplink channel or the like via which information can be sent to the eNB 10, if required), and a resource indication and time period indication for a resource utilization signaling (i.e. an indication of resources in the communication network which is to be used for an RU signaling).

Basically, when resources of the allocated resource pool are reserved or occupied by a D2D cluster, this utilization of resources is signalled to other communication network elements or nodes by means of a RU signaling. The RU signaling may be broadcasted, for example, with a specified time interval or the like in a specific communication resource (included in information received from the eNB with the resource pool information, for example).

According to examples of embodiments of the invention, when a new D2D communication is to be established, in step S120, each newly set up D2D pair/cluster first listens to RU signaling from other UEs or D2D clusters. For this purpose, the information provided by the eNB 10 and indicating the resources in the configured D2D resource pool to be used to RU signaling (i.e. the information concerning the resource and time period for RU signaling) are determined and corresponding signaling is checked.

The resource utilization (RU) signaling may be signalled by broadcasting by a cluster head of a D2D cluster, wherein the RU signaling is sent with a period configured by eNB 10. The RU signaling may indicate the resource utilization in both frequency and time domain. According to an example of embodiment of the invention, a predefined resource dedicated for RU signaling transmission may one of the resources of the configured D2D resource pool, or may be in a reserved resource outside of the D2D resource pool, such as a PUCCH. The orthorgonality of RU signaling from multiple CHs can be guaranteed, for example, by using CDM, FDM or TDM, e.g. PUCCH with an assigned cyclic shift in the edge PRB, wherein a predefined subframe may be used for this purpose.

It is to be noted that the detection of the RU signaling by a CH or UE may be triggered, as indicated, by a D2D resource pool configuration signaling or a D2D resource pool re-configuration signaling, e.g. when a newly configured D2D cluster is set up. On the other hand, as also described below, the detection of the RU signaling by a CH or UE may be triggered by monitoring mode configuration signaling, e.g when a CH or UE is configured to monitor the RU situation and to report correspondingly to the eNB.

In step S130, based on the RU signaling received in step S120, the newly configured D2D pair/cluster determines whether there are suitable resources (i.e. basically free resources) indicated in the allocated resource pool which can be used for the D2D communication to be established, or if there are no or not sufficient suitable resources. In other words, in step S130, occupied resource and vacant resources of the resource pool are determined.

In case it is determined in step S130 that there are suitable resources (YES in step S130), the processing proceeds to step S140. Here, resources of the available (free) resources indicated in the allocated resource pool are selected and reserved for the D2D communication to be established in the own D2D cluster. The number of resources reserved by the D2D cluster may be determined based on a current traffic situation, an actual or expected requirement for the D2D communication, or the like, wherein specific fairness principles or the like may be considered.

It is to be noted that in case the D2D cluster (e.g. UE 20 as CH) does not receive any RU signaling from other communication network elements, it can assume that no adjacent D2D clusters are present. In this case, the whole D2D resource pool is deemed to be vacant.

Next, in step S150, the CH of the D2D duster begins to send an own RU signaling on the dedicated resource in which the resources selected and reserved in step S140 are signalled towards potential listeners (i.e. other CHs).

On the other hand, in case the determination in step S130 is negative, i.e. there are no vacant (or improper) resources detected, the newly configured D2D cluster sends an overload indication (OI) signaling to eNB (step S170).

It is to be noted that before sending the OI, triggered by the determination result of step S130, and in case the information received from the eNB indicating the resource pool comprised at least one further (optional) resource pool or frequency band or the like, a measurement regarding a resource utilization state in this other resource pool(s) is conducted in step S160 (indicated as dashed box in FIG. 3 due to the optional status of this step). In this step S160, it may be determined, in accordance with the processing of steps S120 and S130, whether in this alternative resource pool suitable resources are present. For this purpose, the corresponding RU signaling information concerning the other resource pool are used in order to detect RU signaling from other UEs (D2D clusters) for determining whether and which resources of the alternative resource pool are already used. As a result of step S160, it may be found out that the other resource pool(s) is/are also overloaded or have sufficient resources (i.e. have a low load). In other words, by means of step S160, a load status of the other resource pool(s) is obtained.

Based on the obtained load status, for example in case it is determined that the alternative resource pool has suitable resources left, then the processing may proceed to step S140 (not shown). On the other hand, if also the alternative resource pool does not provide suitable resources, this may be considered as an overload case.

In step S170, the OI is sent to the eNB 10. The OI signaling is sent in reserved UL connectivity resources for the D2D cluster head indicated in the information received in step S110. For example, the OI signaling may re-use a PUSCH or PUCCH transmission format.

In case step S160 is executed, i.e. the load status of another resource pool is also obtained, the OI signaling comprises also a load indication (e.g. overload or low load) of the alternative D2D resource pools (as obtained in step S160). In this case, a CQI report format or the like may be used for the transmission.

As described in connection with FIG. 2, when the eNB 10 detects an OI from one D2D cluster, the eNB 10 decides on the further procedure, i.e. to continue the D2D communication with other resources or to end the D2D mode. Thus, in step S180, the UE 20 being the CH receives a corresponding instruction from the eNB 10 and conducts a corresponding processing, i.e. either ends the establishment of the D2D communication connection or restarts the processing in step S110 with the new resource pool information.

According to a further example of embodiments of the invention, in case a CH decides that additional resources are required for an already established D2D communication, i.e. that the resource utilization is to be increased, the CH has to monitor again the RU signalings according to step S120 and to proceed with steps S130 to S180. That is, the CH may select and reserve further vacant resources, if available, or in case not enough vacant resources are detected, it may send an CA to the eNB 10.

Even not shown in FIG. 3, in case the D2D communication is to be ended, e.g. when the corresponding traffic is completed, the CH may send a resource release indication in the RU signaling, or simply stop sending of the RU signaling, in order to indicate that the previously reserved resources are again vacant.

it to be noted that according to a further example of embodiments of the invention, the RU signaling of a CH may be also monitored by the SNs of the D2D cluster (e.g. SN 30 in FIG. 1). By means of this, the SN is able to obtain information about the resources to be used for the D2D communication in its own cluster. The monitoring of the SNs is not necessarily to be done in each broadcast period of the RU signaling.

As described above, according to the examples of embodiments, resource allocation can be effected in an efficient manner without introducing significant measurement and signaling, wherein also no new transmission format is required. That is, it is possible to efficiently re-use D2D resources, since the broadcasted RU signaling allows the devices (CHs) to learn whether one resource is occupied by an adjacent D2D pair/cluster or not, i.e. to determine whether it is usable or not. Compared with the full control method by eNB, measurement and reports are thus significantly reduced. Furthermore, only broadcast signaling is introduced, and inter-cluster signaling exchange is avoided which simplifies the implementation and device complexity.

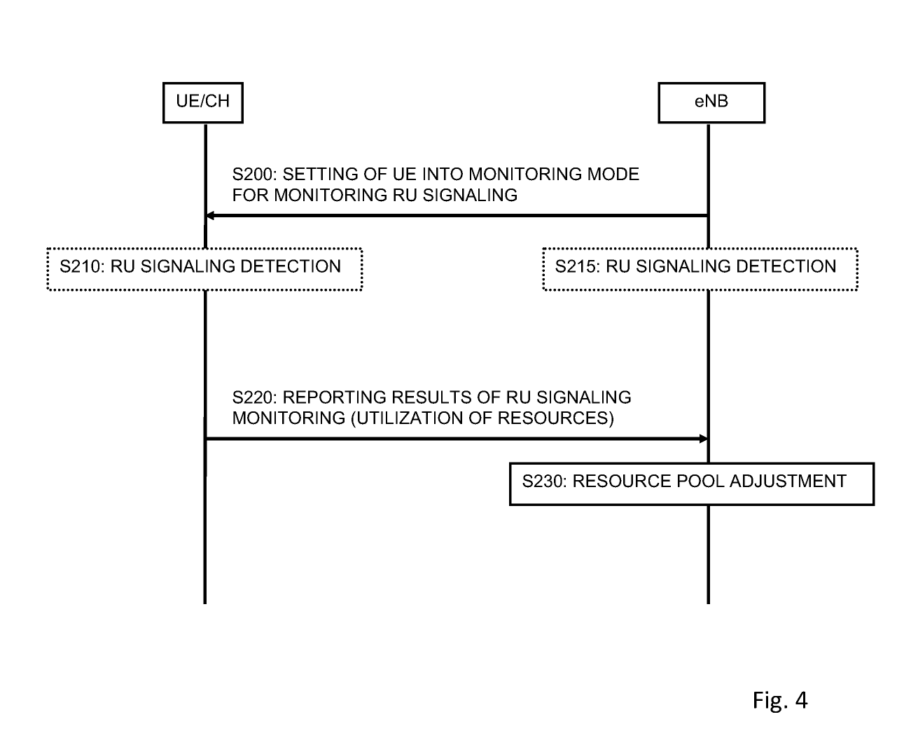

In FIG. 4, a further example of embodiments of the invention is described. It is to be noted that this example is combinable with the examples described in connection with FIGS. 2 and 3.

FIG. 4 shows a signaling diagram illustrating a processing in a resource allocation procedure according to an example of embodiments of the invention. Specifically, the example according to FIG. 4 concerns RU signaling detection and utilization on the eNB side.

According to the present example of embodiments of the invention, the eNB 10 achieves information based on the RU signalling from CHs in its coverage area. On the basis of this information, it is possible to learn the actual resource utilization state for the configured resource pools. Thus, the eNB 10 can already in advance decide whether it is necessary to adjust the presently configured resource pools, e.g. in the frequency or time domain, in order to allow a better utilization of resources by the D2D clusters. The RU signalling can be either directly monitored by the eNB 10, or one or more UEs, such as CHs, may be set into a monitoring mode in which they conduct a periodic monitoring of the RU signalings of other CHs and report monitoring results to the eNB 10.

As indicated in FIG. 4, according to the present example of embodiments of the invention, the RU signalling monitoring is executed by both the eNB 10 and one correspondingly configured CH (as indicated above, RU signalling monitoring may be expected also only by the eNB alone or by one or more configured CHs). In order to configure the UE (CH), in step S200, the eNB sends setting information to the corresponding UE in order to set the UE in the monitoring mode. The setting information may comprise, for example, information about a period for listening to RU signaling, information about format and resources for reporting on the monitoring result, and information about the resource pools which the RU signaling to be monitored is related to.

On the basis of the setting information, the UE being in the monitoring mode starts monitoring of RU signaling in step S210. Alternatively or additionally, in step S215, the eNB starts monitoring of RU signaling, for example on the basis of the same setting information described to be sent in step S200.

In step S220, the CH being in the monitoring mode sends a report to the eNB about the results of the RU signaling monitoring, as indicated in the setting information.

On the basis of the results of the RU signaling monitoring of step S210 and/or 5215, in step S230, the eNB determines whether an adjustment of the D2D resource pool(s) is required, and conducts such an adjustment, if required.

In comparison to the example of embodiments of the invention where a reconfiguration of the resource pools is started not before receiving an OI in step S30, the present example of embodiments of the invention enables the eNB to obtain more information on the D2D resource pool utilization, wherein it is then possible to improve the resource efficiency already in advance.

FIG. 5 shows diagrams 5A to 5D illustrating a resource reservation for signaling according to examples of embodiments of the invention.

Specifically, FIG. 5 shows different possible examples indicating which resources are reserved for required signaling in the propsed resource allocation mechanism.

Diagram 5.A shows an example of time resources used for RU signaling and OI signaling. Indicated by a black box denoted with F2, there are predefined subframe reserved for the RU signaling transmission which are also provided with a predetermined period. Within this period, also a predetermined subframe useable for CH signaling (indicated by the hatched box denoted with F1) is provided. It is to be noted that in the subframe F2 for RU signaling, the CH sends the RU, while at the same time it may also send D2D data/control to devices (SNs) in its cluster. In this subframe F2 for RU signaling, the SNs in one cluster may listen to the RU signaling, as described above, or only listen to the D2D control/data in its own D2D resource pool. In the UL connectivity subframe F1, the CH can only send data/control, e.g. the OI signaling, to the eNB.

Diagrams 5.B to 5.D show frequency resource reservation schemes, wherein there are two D2D bands (D2D band 1 and D2D band 2) indicated in the respective resource pools, and also PUSCH and PUCCH resources are indicated.

In a first scheme, the reserved frequency resource for the RU signaling (indicated by F5) may be outside the configured D2D resource pool resources (i.e. outside the D2D band 1 and D2D band 2), as shown in diagram 5.B. For example the resource to be used for the RU signaling may be in the PUCCH range (indicated with F3). It is to be noted that also a resource for the OI signaling (i.e. uplink connectivity to eNB) is provided, which is indicated by the hatched box with reference sign F4, for example.

Alternatively, the reserved frequency resource F5 for the RU signaling may be in each configured D2D resource pool (D2D band 1 and D2D band 2), as shown in diagram 5.C.

According to a further example, a frequency resource reserved for the RU signaling (see again F5) may be located in the central of each D2D resource pool (D2D band 1 and D2D band 2), as shown in diagram 5.D. In this case, the advantage is that the RU signaling has a better protection against interference by avoiding adjacent channel interference from cellular UEs or the like.

According to examples of embodiments of the invention, in the reserved resources for RU signaling as indicated in FIG. 5, the signaling from different clusters may be multiplexed by using FDM, TDM, or CDM. For example, one possible scheme may use CDM by reusing a current PUCCH format with different cyclic shifts.

According to further examples of embodiments of the invention, in the reserved resources for UL connectivity, a CH which was not able to find suitable resources in the currently allocated D2D resource pool (or to find a sufficient band in the currently allocated D2D resource pool), may send the OI to the eNB. The signaling may be in PUSCH or PUCCH format.

According to examples of embodiments of the invention, a CH may be configured by the eNB to listen to RU signaling in other D2D resource pools under some conditions, e.g. in case of an overload situation in the currently allocated D2D resource pool. A load indication of the resources in the other D2D resource pool may be sent to the eNB in connection with the CH signaling.

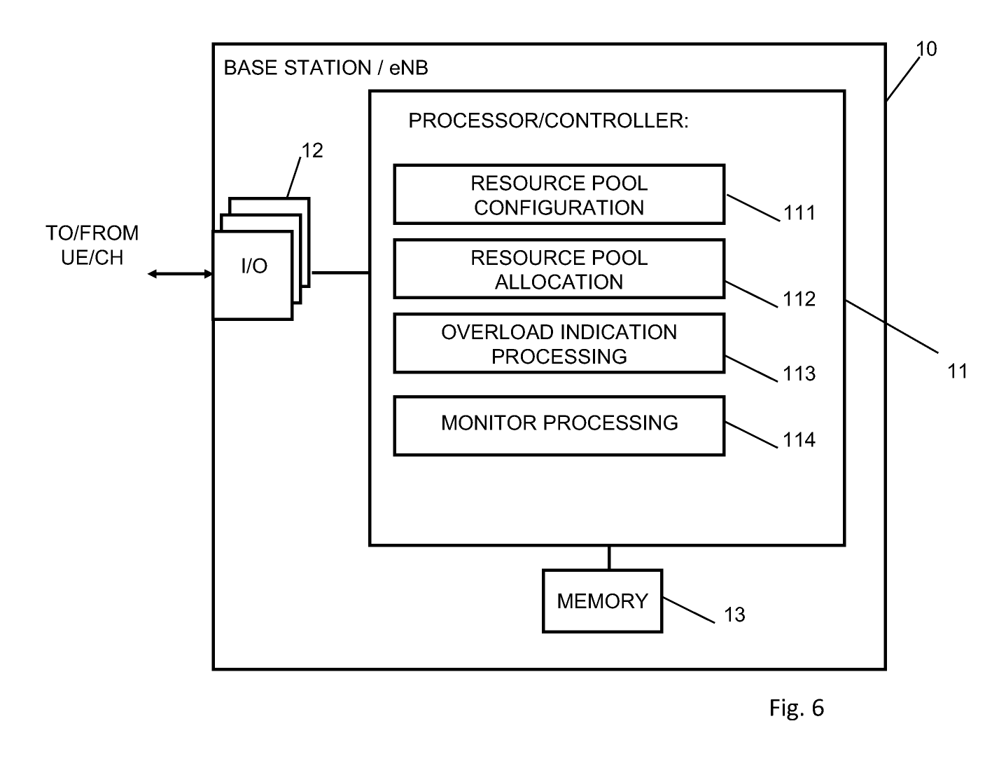

In FIG. 6, a block circuit diagram illustrating a configuration of a communication network control element, such as the eNB 10, is shown, which is configured to implement the processing as described in connection with the examples of embodiments of the invention. It is to be noted that the communication network control device or eNB 10 shown in FIG. 6 may comprise several further elements or functions besides those described herein below, which are omitted herein for the sake of simplicity as they are not essential for understanding the invention. Furthermore, even though reference is made to an eNB, the communication network element may be also another device having a similar function, such as a modem chipset, a chip, a module etc., which can also be part of a BS or attached as a separate element to a BS, or the like.

The communication network control element or eNB 10 may comprise a processing function or processor 11, such as a CPU or the like, which executes instructions given by programs or the like related to the power control. The processor 11 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 12 denote transceiver or input/output (I/O) unit connected to the processor 11. The I/O unit 12 may be used for communicating with elements of the cellular network, such as a communication network element like a UE being a CH. The I/O unit 12 may be a combined unit comprising communication equipment towards several network elements, or may comprise a distributed structure with a plurality of different interfaces for different network elements. Reference sign 13 denotes a memory usable, for example, for storing data and programs to be executed by the processor 11 and/or as a working storage of the processor 11.

The processor 11 is configured to execute processing related to the above described resource allocation mechanism. In particular, the processor 11 comprises a sub-portion 111 as a processing portion which is usable as a resource pool configuration (and re-configuration) section which (re-) configures one or more resource pools for D2D communications. The portion 111 may be configured to perform processing according to step S10 according to FIG. 2, for example. Furthermore, the processor 11 comprises a sub-portion 112 as a processing portion which is usable as a resource pool allocation processing section, which is able to allocate one or more resource pools to a D2D cluster and to generate corresponding information for informing the CH. The portion 112 may be configured, for example, to perform processing according to step S20 according to FIG. 2, for example. Moreover, the processor 11 comprises a sub-portion 113 as a processing portion which is usable as an overload indication processing section for processing an OI received from a CH and to decide about the further processing. The portion 113 may be configured, for example, to perform processing according to steps S30 to S50 according to FIG. 2, for example. In addition, the processor 11 comprises a sub-portion 114 as a processing portion which is usable as a monitor processing section for conducting a RU signaling monitoring. The portion 114 may be configured, for example, to perform processing according to steps S200, S215 and S230 according to FIG. 4, for example.

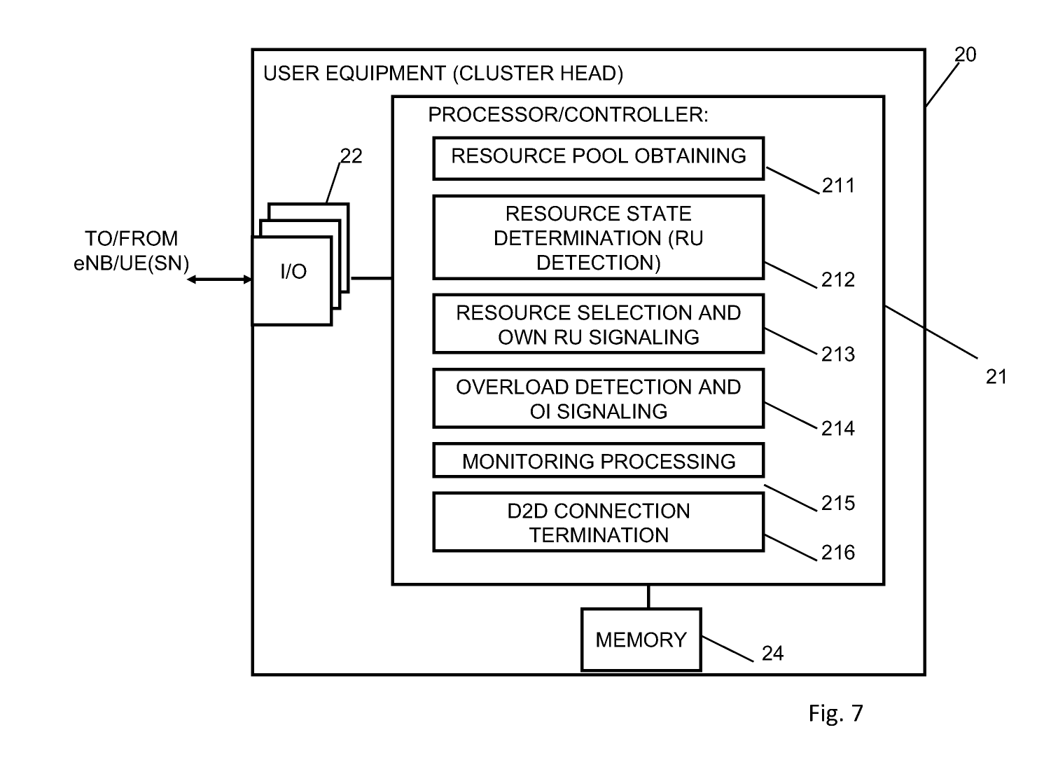

In FIG. 7, a block circuit diagram illustrating a configuration of a communication network element, such as of UE 20 being a CH, is shown, which is configured to implement the processing as described in connection with the examples of embodiments of the invention, for example. It is to be noted that the communication network device or UE 20 shown in FIG. 7 may comprise several further elements or functions besides those described herein below, which are omitted herein for the sake of simplicity as they are not essential for understanding the invention. Furthermore, even though reference is made to a UE, the communication network element may be also another device having a similar function, such as a modem chipset, a chip, a module etc., which can also be part of a UE or attached as a separate element to a UE, or the like.

The communication network element or UE 20 may comprise a processing function or processor 21, such as a CPU or the like, which executes instructions given by programs or the like related to the power control. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 22 denotes transceiver or input/output (I/O) units connected to the processor 21. The I/O units 22 may be used for communicating with elements of the cellular network, such as a communication network control element like an eNB, or with SNs of the D2D communication connection. The I/O units 22 may be a combined unit comprising communication equipment towards several of the network element in question, or may comprise a distributed structure with a plurality of different interfaces for each network element in question. Reference sign 24 denotes a memory usable, for example, for storing data and programs to be executed by the processor 21 and/or as a working storage of the processor 21.

The processor 21 is configured to execute processing related to the above described resource allocation mechanism. In particular, the processor 21 comprises a sub-portion 211 as a processing portion which is usable as a resource pool obtaining section or D2D cluster set up section which processes the information provided by the eNB concerning the resource pool and signaling configuration. The portion 211 may be configured to perform processing according to step S110 according to FIG. 3, for example. Furthermore, the processor 21 comprises a sub-portion 212 as a processing portion which is usable as a resource state determination section for determining the resource utilization in the allocated resource pool. The portion 212 may be configured to perform processing according to steps S120 and S130 according to FIG. 3, for example. Moreover, the processor 21 comprises a sub-portion 213 as a processing portion which is usable as a resource selection section and as a section for preparing and signaling the own RU signaling. The portion 213 may be configured to perform processing according to steps S140 and S150 according to FIG. 3, for example. In addition, the processor 21 comprises a sub-portion 214 as a processing portion which is usable as an overload (or load) detection and OI signaling section. The portion 214 may be configured to perform processing according to steps S160 and S170 according to FIG. 3, for example. Furthermore, the processor 21 comprises a sub-portion 215 as a processing portion which is usable as a monitoring processing section for performing operation in a monitoring mode. The portion 215 may be configured to perform processing according to steps S210 and S220 according to FIG. 4, for example. Moreover, the processor 21 comprises a sub-portion 216 as a processing portion which is usable as a D2D connection termination section which ends a D2D communication and stops or modifies the RU signaling.

As described above, examples of embodiments of the invention concerning the resource allocation mechanism are described to be implemented in UEs and eNBs. However, the invention is not limited to this. For example, examples of embodiments of the invention may be implemented in any wireless modems or the like.

According to a further example of embodiments of the invention, there is provided an apparatus comprising transceiving means for conducting a communication with communication network elements, a resource pool configuration processing means for configuring one or more resource pools each comprising a plurality of dedicated communication resources usable for a device-to-device communication between two or more communication network elements, an allocation processing means for allocating at least one of the one or more resource pools to a group of communication network elements establishing a device-to-device communication connection, wherein the at least one of the one or more resource pools is allocated to the group of communication network elements for allowing a group head communication network element to select a set of communication resources comprised in the least one of the one or more resource pools for the device-to-device communication connection to be established, and wherein the allocation processing means is configured to send information indicating the at least one of the one or more resource pools to the group head communication network element.

Moreover, according to an example of embodiments of the invention, there is provided an apparatus comprising transceiving means for conducting a device-to-device communication with at least one communication network element and to communicate with a communication network control element, a resource information obtaining processing means for obtaining from the communication network control element information indicating at least one allocated resource pool, wherein each resource pool comprises a plurality of dedicated communication resources usable for a device-to-device communication between two or more communication network elements, and a resource state determination processing means for determining, based on a detection of a foreign resource utilization signaling from another communication network element, which communication resources of the plurality of dedicated communication resources of the allocated at least one resource pool are improper for being used as a resource for a device-to-device communication or which communication resources of the plurality of dedicated communication resources of the allocated at least one resource pool are suitable for being used as a resource for a device-to-device communication.

Moreover, according to an example of embodiments of the invention, there is provided an apparatus comprising transceiving means for conducting a device-to-device communication with at least one communication network element, wherein one of the at least one communication network element is a master node of the device-to-device communication, and a resource obtaining processing means for obtaining, on the basis of a detection of a resource utilization signaling from the master node of the device-to-device communication, communication resources of a plurality of dedicated communication resources as resources for the device-to-device communication.

For the purpose of the present invention as described herein above, it should be noted that
an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present invention implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable communication networks and transmission nodes may be or comprise any device, apparatus, unit or means by which a station, entity or other user equipment may connect to and/or utilize services offered by the access network; such services include, among others, data and/or (audio-) visual communication, data download etc.;
a user equipment or communication network element may be any device, apparatus, unit or means by which a system user or subscriber may experience services from an access network, such as a mobile phone, personal digital assistant PDA, or computer, or a device having a corresponding functionality, such as a modem chipset, a chip, a module etc., which can also be part of a UE or attached as a separate element to a UE, or the like;
method steps likely to be implemented as software code portions and being run using a processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to examples of embodiments of the invention, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is provided a mechanism for allocating communication resources of a cellular communication network to a D2D communication. After an eNB has configured a number of resource pools indicating a set of resources usable in the D2D communication, D2D clusters which share a same resource pool are enabled to obtain resources for their respective D2D communication. By detecting the current resource utilization state in the allocated resource pool by measurement on the UE side, it is decided whether suitable resources are available or not. An overload situation is signalled to the eNB if no suitable resource can be detected.

Although the present invention has been described herein before with reference to particular embodiments thereof, the present invention is not limited thereto and various modifications can be made thereto.

According to further examples, the following aspects can be provided:

1. aspect: An apparatus comprising a transceiver configured to conduct a communication with communication network elements, a resource pool configuration processing portion configured to configure one or more resource pools each comprising a plurality of dedicated communication resources usable for a device-to-device communication between two or more communication network elements, an allocation processing portion configured to allocate at least one of the one or more resource pools to a group of communication network elements establishing a device-to-device communication connection, wherein the at least one of the one or more resource pools is allocated to the group of communication network elements for allowing a group head communication network element to select a set of communication resources comprised in the least one of the one or more resource pools for the device-to-device communication connection to be established, and wherein the allocation processing portion is configured to send information indicating the at least one of the one or more resource pools to the group head communication network element.
2. aspect: The apparatus according to the first aspect, wherein the allocation processing portion is further configured to allocate the at least one of the one or more resource pools allocated to the group of communication network elements establishing a device-to-device communication connection also to at least one other group of communication network elements establishing a further device-to-device communication connection.
3. aspect: The apparatus according to the first aspect, further comprising an overload indication processing portion configured to receive, via the transceiver, and to process an overload indication from at least one communication network element, wherein the allocation processing portion is further configured, when the overload indication processing portion receives the overload indication, to allocate at least one further resource pool to a group of communication network elements concerned by the overload indication, or to instruct the resource pool configuration processing portion to re-configure the at least one resource pool allocated to a group of communication network elements concerned by the overload indication and to allocate a resulting new resource pool to the group of communication network elements concerned by the overload indication, or to instruct a group of communication network elements concerned by the overload indication to end the establishment of the device-to-device communication connection.
4. aspect: The apparatus according to the 3. aspect, wherein the overload indication is received via a reserved uplink connection resource.
5. aspect: The apparatus according to the 1. aspect, further comprising a monitor processing portion configured to monitor a resource utilization signaling from groups of communication network elements to which at least one of the one or more resource pools is allocated, wherein the resource utilization signaling indicates which resources of the at least one of the one or more resource pools are used by the group of communication network elements, and to determine whether a load situation in a communication using the resources of the at least one of the one or more resource pools requires an adjustment of resource pools, wherein the resource pool configuration processing portion is further configured to adjust the configured one or more resource pools on the basis of the determination result of the monitor processing portion.
6. aspect: The apparatus according to the 5. aspect, wherein the monitor processing portion is further configured to set at least one communication network element to a monitoring mode in which the at least one communication network element conducts monitoring of the resource utilization signaling from groups of communication network elements to which at least one of the one or more resource pools is allocated, and sends the monitoring result to the monitor processing portion, wherein the monitor processing portion is further configured to use the sent monitoring results in the determination of whether the load situation in a communication using the resources of the at least one of the one or more resource pools requires an adjustment of resource pools.
7, aspect: The apparatus according to the 1. aspect, wherein the information indicating the at least one of the one or more resource pools being sent to the group head communication network element comprises at least one of the following information elements: a communication network element identification in the group of communication network elements, a first communication band indication for the device-to-device communication for the group of communication network elements, a second communication band indication for the device-to-device communication for the group of communication network elements, a resource indication for connectivity between the group of communication network elements and a communication network control element, and a resource indication and time period indication for a resource utilization signaling.
8. aspect: The apparatus according to the 1. aspect, wherein a group of communication network elements comprises a pair of communication network elements or a cluster of three or more communication network elements, wherein one of the communication network elements represents a group head communication network element and the one or more of the other communication network elements represent slave nodes of the group of communication network elements.
9. aspect: A method comprising conducting a communication with communication network elements, configuring one or more resource pools each comprising a plurality of dedicated communication resources usable for a device-to-device communication between two or more communication network elements, allocating at least one of the one or more resource pools to a group of communication network elements establishing a device-to-device communication connection, and sending information indicating the at least one of the one or more resource pools to a group head communication network element, wherein the at least one of the one or more resource pools is allocated to the group of communication network elements for allowing the group head communication network element to select a set of communication resources comprised in the least one of the one or more resource pools for the device-to-device communication connection to be established.
10. aspect: The method according to the 9. aspect, further comprising allocating the at least one of the one or more resource pools allocated to the group of communication network elements establishing a device-to-device communication connection also to at least one other group of communication network elements establishing a further device-to-device communication connection.
11. aspect: The method according to the 9. aspect, further comprising receiving and processing an overload indication from at least one communication network element, and when the overload indication processing portion receives the overload indication, allocating at least one further resource pool to a group of communication network elements concerned by the overload indication, or instructing to re-configure the at least one resource pool allocated to a group of communication network elements concerned by the overload indication and allocating a resulting new resource pool to the group of communication network elements concerned by the overload indication, or instructing a group of communication network elements concerned by the overload indication to end the establishment of the device-to-device communication connection.
12. aspect: The method according to claim 11. aspect, wherein the overload indication is received via a reserved uplink connection resource.
13. aspect: The method according to the 9. aspect, further comprising monitoring a resource utilization signaling from groups of communication network elements to which at least one of the one or more resource pools is allocated, wherein the resource utilization signaling indicates which resources of the at least one of the one or more resource pools are used by the group of communication network elements, determining whether a load situation in a communication using the resources of the at least one of the one or more resource pools requires an adjustment of resource pools, and adjusting the configured one or more resource pools on the basis of the determination result of the monitor processing portion.
14. aspect: The method according to the 13. aspect, further comprising setting at least one communication network element to a monitoring mode in which the at least one communication network element conducts monitoring of the resource utilization signaling from groups of communication network elements to which at least one of the one or more resource pools is allocated, receiving the monitoring result of the least one communication network element set to the monitoring mode, and using the sent monitoring results in the determination of whether the load situation in a communication using the resources of the at least one of the one or more resource pools requires an adjustment of resource pools.
15. aspect: The method according to the 9. aspect, wherein the information indicating the at least one of the one or more resource pools being sent to the group head communication network element comprises at least one of the following information elements: a communication network element identification in the group of communication network elements, a first communication band indication for the device-to-device communication for the group of communication network elements, a second communication band indication for the device-to-device communication for the group of communication network elements, a resource indication for connectivity between the group of communication network elements and a communication network control element, and a resource indication and time period indication for a resource utilization signaling.
16. aspect: The method according to the 9. aspect, wherein a group of communication network elements comprises a pair of communication network elements or a cluster of three or more communication network elements, wherein one of the communication network elements represents a group head communication network element and the one or more of the other communication network elements represent slave nodes of the group of communication network elements.
17. aspect: An apparatus comprising a transceiver configured to conduct a device-to-device communication with at least one communication network element and to communicate with a communication network control element, a resource information obtaining processing portion configured to obtain from the communication network control element information indicating at least one allocated resource pool, wherein each resource pool comprises a plurality of dedicated communication resources usable for a device-to-device communication between two or more communication network elements, and a resource state determination processing portion configured to determine, based on a detection of a foreign resource utilization signaling from another communication network element, which communication resources of the plurality of dedicated communication resources of the allocated at least one resource pool are improper for being used as a resource for a device-to-device communication or which communication resources of the plurality of dedicated communication resources of the allocated at least one resource pool are suitable for being used as a resource for a device-to-device communication.
18. aspect: The apparatus according to the 17. aspect, further comprising a resource selection processing portion configured to select, on the basis of the determination of the resource state determination processing portion, suitable communication resources of the plurality of dedicated communication resources of the allocated at least one resource pool as a resource for a device-to-device communication to a communication network element, and a resource utilization signaling processing portion configured to send an own resource utilization signaling via the transceiver, wherein the own resource utilization signaling indicates which resources of the at least one resource pool is selected by the resource selection processing portion to be used in the device-to-device communication.
19. aspect: The apparatus according to the 18. aspect, wherein the resource selection processing portion is configured to determine, on the basis of the information from the communication network control element, communication resources to be used to send the resource utilization signaling, wherein the resource utilization signaling is sent by using one of code division multiplexing, time division multiplexing and frequency division multiplexing by using specified communication resources reserved in resources of the allocated resource pool or in resources outside the allocated resource pool, and wherein the resource utilization signaling provides information indicating a utilization of the communication resources in at least one of a time domain and a frequency domain.
20. aspect: The apparatus according to the 17. aspect, further comprising an overload detection processing portion configured to detect, on the basis of the determination of the resource state determination processing portion of improper communication resources of the plurality of dedicated communication resources of the allocated at least one resource pool, that the allocated resource pool does not comprise suitable resources for the device-to-device communication to a communication network element, and an overload indication signaling processing portion configured to send an overload indication signaling via the transceiver to the communication network control element, wherein the overload indication signaling indicates that the allocated resource pool is not suitable for providing resources to be used in the device-to-device communication.
21. aspect: The apparatus according to the 20. aspect, wherein the overload indication signaling processing portion is configured to determine, on the basis of the information from the communication network control element, communication resources to be used to send the overload indication signaling,
22. aspect: The apparatus according to the 20. aspect, wherein in case the overload detection processing portion detects that the allocated resource pool does not comprise suitable resources for the device-to-device communication to a communication network element, and the resource information obtaining processing portion has obtained from the communication network control element information indicating more than one allocated resource pool, the resource state determination processing portion is further configured to determine, based on a detection of a foreign resource utilization signaling from another communication network element, whether communication resources of the plurality of dedicated communication resources of another allocated resource pool are suitable for being used as a resource for a device-to-device communication,
23. aspect: The apparatus according to the 22 aspect, wherein the overload indication signaling processing portion is further configured to send a load status information together with an overload indication signaling via the transceiver to the communication network control element on the basis of the determination related to the other allocated resource pool.
24. aspect: The apparatus according to the 20. aspect, wherein the resource information obtaining processing portion is further configured to obtain, in response to the overload indication signaling, new information indicating at least one new allocated resource pool, and the resource state determination processing portion is further configured to determine, based on a detection of a foreign resource utilization signaling from another communication network element, which communication resources of the plurality of dedicated communication resources of the allocated at least one new resource pool are improper for being used as a resource for a device-to-device communication or which communication resources of the plurality of dedicated communication resources of the allocated at least one new resource pool are suitable for being used as a resource for a device-to-device communication.
25. aspect: The apparatus according to the 17 aspect, further comprising a monitoring processing portion configured to monitor, when a monitoring mode is set by the communication network control element, resource utilization signaling from communication network elements and to send a monitoring result to the communication network control element.
26. aspect: The apparatus according to the 17. aspect, further comprising a resource increasing processing portion configured to determine that additional communication resources are required for a device-to-device communication, wherein the resource state determination processing portion is further configured to determine, based on a detection of a foreign resource utilization signaling from another communication network element, whether communication resources of the plurality of dedicated communication resources of the allocated at least one resource pool are available for increasing the number of resources being suitable for the device-to-device communication.
27. aspect: The apparatus according to the 18. aspect, further comprising a connection termination processing portion configured to determine that the device-to-device communication is ended, wherein the connection termination processing portion is further configured to cause, when the device-to-device communication is ended, the resource utilization signaling processing portion to send a resource release indication message in the resource utilization signaling, or to stop the resource utilization signaling.
28. aspect: The apparatus according to the 17 aspect, wherein the information indicating the at least one resource pool comprises at least one of the following information elements: a communication network element identification in a group of communication network elements for which a device-to-device communication is to be established, a first communication band indication for the device-to-device communication for the group of communication network elements, a second communication band indication for the device-to-device communication for the group of communication network elements, a resource indication for connectivity between the transceiver and the communication network control element, and a resource indication and time period indication for a resource utilization signaling.
29. aspect: The apparatus according to the 17. aspect, wherein the device-to-device communication is to be established in a group of communication network elements comprising a pair of communication network elements or a cluster of three or more communication network elements, wherein one of the communication network elements represents a group head communication network element and the one or more of the other communication network elements represent slave nodes of the group of communication network elements.
30. aspect: A method comprising establishing a device-to-device communication with at least one communication network element and communicating with a communication network control element, obtaining from the communication network control element information indicating at least one allocated resource pool, wherein each resource pool comprises a plurality of dedicated communication resources usable for a device-to-device communication between two or more communication network elements, and determining, based on a detection of a foreign resource utilization signaling from another communication network element, a resource state indicating which communication resources of the plurality of dedicated communication resources of the allocated at least one resource pool are improper for being used as a resource for a device-to-device communication or which communication resources of the plurality of dedicated communication resources of the allocated at least one resource pool are suitable for being used as a resource for a device-to-device communication.
31. aspect: The method according to the 30. aspect, further comprising selecting, on the basis of the determination of the resource state, suitable communication resources of the plurality of dedicated communication resources of the allocated at least one resource pool as a resource for a device-to-device communication to a communication network element, and sending an own resource utilization signaling via the transceiver, wherein the own resource utilization signaling indicates which resources of the at least one resource pool are selected in the selection processing to be used in the device-to-device communication.
32. aspect: The method according to the 31. aspect, further comprising determining, on the basis of the information from the communication network control element, communication resources to be used to send the resource utilization signaling, wherein the resource utilization signaling is sent by using one of code division multiplexing, time division multiplexing and frequency division multiplexing by using specified communication resources reserved in resources of the allocated resource pool or in resources outside the allocated resource pool, and wherein the resource utilization signaling provides information indicating a utilization of the communication resources in at least one of a time domain and a frequency domain.
33. aspect: The method according to the 30. aspect, further comprising detecting, on the basis of the determination of improper communication resources of the plurality of dedicated communication resources of the allocated at least one resource pool, that the allocated resource pool does not comprise suitable resources for the device-to-device communication to a communication network element, and sending an overload indication signaling via the transceiver to the communication network control element, wherein the overload indication signaling indicates that the allocated resource pool is not suitable for providing resources to be used in the device-to-device communication.
34. aspect: The method according to the 33. aspect, further comprising determining, on the basis of the information from the communication network control element, communication resources to be used to send the overload indication signaling.
35. aspect: The method according to the 33. aspect, wherein in case it is detected that the allocated resource pool does not comprise suitable resources for the device-to-device communication to a communication network element, and the information obtained from the from the communication network control element indicates more than one allocated resource pool, the method further comprises determining, based on a detection of a foreign resource utilization signaling from another communication network element, whether communication resources of the plurality of dedicated communication resources of another allocated resource pool are suitable for being used as a resource for a device-to-device communication,
36. aspect: The method according to the 35. aspect, further comprising sending a load status information together with an overload indication signaling via the transceiver to the communication network control element on the basis of the determination related to the other allocated resource pool.
37. aspect: The method according to the 33. aspect, further comprising obtaining, in response to the overload indication signaling, new information indicating at least one new allocated resource pool, and determining, based on a detection of a foreign resource utilization signaling from another communication network element, which communication resources of the plurality of dedicated communication resources of the allocated at least one new resource pool are improper for being used as a resource for a device-to-device communication or which communication resources of the plurality of dedicated communication resources of the allocated at least one new resource pool are suitable for being used as a resource for a device-to-device communication.
38. aspect: The method according to the 30. aspect, further comprising monitoring, when a monitoring mode is set by the communication network control element, resource utilization signaling from communication network elements and to send a monitoring result to the communication network control element.
39. aspect: The method according to the 30. aspect, further comprising determining that additional communication resources are required for a device-to-device communication, and determining, based on a detection of a foreign resource utilization signaling from another communication network element, whether communication resources of the plurality of dedicated communication resources of the allocated at least one resource pool are available for increasing the number of resources being suitable for the device-to-device communication.
40. aspect: The method according to the 31. aspect, further comprising determining that the device-to-device communication is ended, and further comprising sending a resource release indication message in the resource utilization signaling, or stopping the resource utilization signaling.
41. aspect: The method according to the 30. aspect, wherein the information indicating the at least one resource pool comprises at least one of the following information elements: a communication network element identification in a group of communication network elements for which a device-to-device communication is to be established, a first communication band indication for the device-to-device communication for the group of communication network elements, a second communication band indication for the device-to-device communication for the group of communication network elements, a resource indication for connectivity between the transceiver and the communication network control element, and a resource indication and time period indication for a resource utilization signaling.
42. aspect: The method according to the 30. aspect, wherein the device-to-device communication is to be established in a group of communication network elements comprising a pair of communication network elements or a cluster of three or more communication network elements, wherein one of the communication network elements represents a group head communication network element and the one or more of the other communication network elements represent slave nodes of the group of communication network elements.
43. aspect: An apparatus comprising a transceiver configured to conduct a device-to-device communication with at least one communication network element, wherein one of the at least one communication network element is a master node of the device-to-device communication, and a resource obtaining processing portion configured to obtain, on the basis of a detection of a resource utilization signaling from the master node of the device-to-device communication, communication resources of a plurality of dedicated communication resources as resources for the device-to-device communication.
44. aspect: The apparatus according to the 43. aspect, wherein the resource utilization signaling is sent by using one of code division multiplexing, time division multiplexing and frequency division multiplexing by using specified communication resources reserved in resources of the allocated resource pool or in resources outside the allocated resource pool, and wherein the resource utilization signaling provides information indicating a utilization of the communication resources in at least one of a time domain and a frequency domain.
45. aspect: A method comprising establishing a device-to-device communication with at least one communication network element, wherein one of the at least one communication network element is a master node of the device-to-device communication, and obtaining, on the basis of a detection of a resource utilization signaling from the master node of the device-to-device communication, communication resources of a plurality of dedicated communication resources as resources for the device-to-device communication.
46. aspect: The method according to the 45. aspect, wherein the resource utilization signaling is sent by using one of code division multiplexing, time division multiplexing and frequency division multiplexing by using specified communication resources reserved in resources of the allocated resource pool or in resources outside the allocated resource pool, and wherein the resource utilization signaling provides information indicating a utilization of the communication resources in at least one of a time domain and a frequency domain.
47. aspect: A computer program product for a computer, comprising software code portions for performing the steps of the 9. aspect when said product is run on the computer.
48. aspect: A computer program product for a computer, comprising software code portions for performing the steps of the 30. aspect when said product is run on the computer.
49. aspect: A computer program product for a computer, comprising software code portions for performing the steps of the 45. aspect when said product is run on the computer.

1. An apparatus comprising
a transceiver configured to conduct a communication with communication network elements,
a resource pool configuration processing portion configured to configure one or more resource pools each comprising a plurality of dedicated communication resources usable for a device-to-device communication between two or more communication network elements,
an allocation processing portion configured to allocate at least one of the one or more resource pools to a group of communication network elements establishing a device-to-device communication connection,
wherein the at least one of the one or more resource pools is allocated to the group of communication network elements for allowing a group head communication network element to select a set of communication resources comprised in the least one of the one or more resource pools for the device-to-device communication connection to be established, and
wherein the allocation processing portion is configured to send information indicating the at least one of the one or more resource pools to the group head communication network element.

2-8. (canceled)

9. A method comprising
conducting a communication with communication network elements,
configuring one or more resource pools each comprising a plurality of dedicated communication resources usable for a device-to-device communication between two or more communication network elements,
allocating at least one of the one or more resource pools to a group of communication network elements establishing a device-to-device communication connection, and
sending information indicating the at least one of the one or more resource pools to a group head communication network element,
wherein the at least one of the one or more resource pools is allocated to the group of communication network elements for allowing the group head communication network element to select a set of communication resources comprised in the least one of the one or more resource pools for the device-to-device communication connection to be established.

10. The method according to claim 9, further comprising allocating the at least one of the one or more resource pools allocated to the group of communication network elements establishing a device-to-device communication connection also to at least one other group of communication network elements establishing a further device-to-device communication connection.

11. The method according to claim 9, further comprising
receiving and processing an overload indication from at least one communication network element, and when the overload indication processing portion receives the overload indication,
allocating at least one further resource pool to a group of communication network elements concerned by the overload indication, or
instructing to re-configure the at least one resource pool allocated to a group of communication network elements concerned by the overload indication and allocating a resulting new resource pool to the group of communication network elements concerned by the overload indication, or
instructing a group of communication network elements concerned by the overload indication to end the establishment of the device-to-device communication connection.

12. The method according to claim 11, wherein the overload indication is received via a reserved uplink connection resource.

13. The method according to claim 9, further comprising
monitoring a resource utilization signaling from groups of communication network elements to which at least one of the one or more resource pools is allocated, wherein the resource utilization signaling indicates which resources of the at least one of the one or more resource pools are used by the group of communication network elements,
determining whether a load situation in a communication using the resources of the at least one of the one or more resource pools requires an adjustment of resource pools, and
adjusting the configured one or more resource pools on the basis of the determination result of the monitor processing portion.

14. The method according to claim 13, further comprising
setting at least one communication network element to a monitoring mode in which the at least one communication network element conducts monitoring of the resource utilization signaling from groups of communication network elements to which at least one of the one or more resource pools is allocated,
receiving the monitoring result of the least one communication network element set to the monitoring mode, and
using the sent monitoring results in the determination of whether the load situation in a communication using the resources of the at least one of the one or more resource pools requires an adjustment of resource pools.

15. The method according to claim 9, wherein the information indicating the at least one of the one or more resource pools being sent to the group head communication network element comprises at least one of the following information elements: a communication network element identification in the group of communication network elements, a first communication band indication for the device-to-device communication for the group of communication network elements, a second communication band indication for the device-to-device communication for the group of communication network elements, a resource indication for connectivity between the group of communication network elements and a communication network control element, and a resource indication and time period indication for a resource utilization signaling.

16. The method according to claim 9, wherein a group of communication network elements comprises a pair of communication network elements or a cluster of three or more communication network elements, wherein one of the communication network elements represents a group head communication network element and the one or more of the other communication network elements represent slave nodes of the group of communication network elements.

17-29. (canceled)

30. A method comprising
establishing a device-to-device communication with at least one communication network element and communicating with a communication network control element,
obtaining from the communication network control element information indicating at least one allocated resource pool, wherein each resource pool comprises a plurality of dedicated communication resources usable for a device-to-device communication between two or more communication network elements, and
determining, based on a detection of a foreign resource utilization signaling from another communication network element, a resource state indicating which communication resources of the plurality of dedicated communication resources of the allocated at least one resource pool are improper for being used as a resource for a device-to-device communication or which communication resources of the plurality of dedicated communication resources of the allocated at least one resource pool are suitable for being used as a resource for a device-to-device communication.

31. The method according to claim 30, further comprising
selecting, on the basis of the determination of the resource state, suitable communication resources of the plurality of dedicated communication resources of the allocated at least one resource pool as a resource for a device-to-device communication to a communication network element, and
sending an own resource utilization signaling via the transceiver, wherein the own resource utilization signaling indicates which resources of the at least one resource pool are selected in the selection processing to be used in the device-to-device communication.

32. The method according to claim 31, further comprising determining, on the basis of the information from the communication network control element, communication resources to be used to send the resource utilization signaling,
wherein the resource utilization signaling is sent by using one of code division multiplexing, time division multiplexing and frequency division multiplexing by using specified communication resources reserved in resources of the allocated resource pool or in resources outside the allocated resource pool, and
wherein the resource utilization signaling provides information indicating a utilization of the communication resources in at least one of a time domain and a frequency domain.

33. The method according to claim 30, further comprising
detecting, on the basis of the determination of improper communication resources of the plurality of dedicated communication resources of the allocated at least one resource pool, that the allocated resource pool does not comprise suitable resources for the device-to-device communication to a communication network element, and
sending an overload indication signaling via the transceiver to the communication network control element, wherein the overload indication signaling indicates that the allocated resource pool is not suitable for providing resources to be used in the device-to-device communication.

34. The method according to claim 33, further comprising
determining, on the basis of the information from the communication network control element, communication resources to be used to send the overload indication signaling.

35. The method according to claim 33, wherein
in case it is detected that the allocated resource pool does not comprise suitable resources for the device-to-device communication to a communication network element, and the information obtained from the from the communication network control element indicates more than one allocated resource pool, the method further comprises determining, based on a detection of a foreign resource utilization signaling from another communication network element, whether communication resources of the plurality of dedicated communication resources of another allocated resource pool are suitable for being used as a resource for a device-to-device communication,

36. The method according to claim 35, further comprising sending a load status information together with an overload indication signaling via the transceiver to the communication network control element on the basis of the determination related to the other allocated resource pool.

37. The method according to claim 33, further comprising
obtaining, in response to the overload indication signaling, new information indicating at least one new allocated resource pool, and
determining, based on a detection of a foreign resource utilization signaling from another communication network element, which communication resources of the plurality of dedicated communication resources of the allocated at least one new resource pool are improper for being used as a resource for a device-to-device communication or which communication resources of the plurality of dedicated communication resources of the allocated at least one new resource pool are suitable for being used as a resource for a device-to-device communication.

38. The method according to claim 30, further comprising
monitoring, when a monitoring mode is set by the communication network control element, resource utilization signaling from communication network elements and to send a monitoring result to the communication network control element.

39. The method according to claim 30, further comprising
determining that additional communication resources are required for a device-to-device communication, and
determining, based on a detection of a foreign resource utilization signaling from another communication network element, whether communication resources of the plurality of dedicated communication resources of the allocated at least one resource pool are available for increasing the number of resources being suitable for the device-to-device communication.

40. The method according to claim 31, further comprising
determining that the device-to-device communication is ended, and further comprising
sending a resource release indication message in the resource utilization signaling, or
stopping the resource utilization signaling.

41-50. (canceled)
